(19) United States
(12) Patent Application Publication
(10) Pub. No.: US 2023/0126949 A1
(43) Pub. Date: Apr. 27, 2023

(54) DETECTION METHOD USING FREQUENCY MODULATED CONTINUOUS WAVE, RADAR, AND COMPUTER-READABLE STORAGE MEDIUM

(71) Applicant: HESAI TECHNOLOGY CO., LTD., Shanghai (CN)

(72) Inventors: Xin LONG, SHANGHAI (CN); Shaoqing XIANG, SHANGHAI (CN)

(21) Appl. No.: 18/085,143

(22) Filed: Dec. 20, 2022

Related U.S. Application Data
(63) Continuation of application No. PCT/CN2021/089345, filed on Apr. 23, 2021.

(30) Foreign Application Priority Data
Aug. 21, 2020 (CN) 202010851384.3

(51) Int. Cl. G01S 13/34

(52) U.S. Cl. CPC G01S 13/345

(57) ABSTRACT

A detection method using a frequency modulated continuous wave, a radar, and a computer-readable storage medium. The method includes: emitting a detection wave to detect a target object, where the detection wave is a nonlinear frequency sweep modulated signal; receiving an echo of the detection wave reflected by the target object; obtaining an actual beat frequency signal according to the echo and the detection wave; and obtaining a distance and/or velocity of the target object according to the actual beat frequency signal. By the method, the decoupling and separation of distance/velocity information may be completed in a single cycle. The decoupling and separation of a distance/velocity can be completed within a single frequency sweep cycle, and a detection probability of a system is kept from deteriorating.

### CROSS-REFERENCE TO RELATED APPLICATIONS

This application is a Continuation Application of International Patent Application No. PCT/CN2021/089345, filed on Apr. 23, 2021, which is based on and claims priority to and benefits of Chinese Patent Application No. 202010851384.3, filed on Aug. 21, 2020. The entire content of all of the above identified applications is incorporated herein by reference.

### TECHNICAL FIELD

The present invention relates to the field of photoelectric detection technologies, and more specifically, to a detection method using a frequency modulated continuous wave, a radar, and a computer-readable storage medium

### BACKGROUND

A frequency modulated continuous wave (FMCW) radar is a continuous wave radar whose transmitting frequency is modulated by a specific signal. FMCW radar obtains distance information of a target by comparing a difference between a frequency of an echo signal at any moment and a frequency of an emitting signal at the moment, and a distance is proportional to a frequency difference between the two. A radial velocity and distance of the target may be obtained by processing the measured frequency difference between the two. Compared with other types of ranging and velocity measuring radars, the FMCW radar has a simpler structure. A lower peak value of transmitting power required, easy to modulate, low cost, and simple signal processing make it a commonly used radar scheme.

In FMCW radar, a linear frequency sweep signal is generally used as a transmitting signal of the radar. Distance as well as velocity information of a detection target will cause a frequency of a final detected beat frequency signal to change. To separate the distance and velocity information of the detection target, multi-frequency sweep modulation or double sideband modulation scheme is generally used. FIG. 1A shows a multi-frequency sweep modulation scheme, in which a modulation signal is combined with a plurality of linear frequency sweep with different frequency sweep rates in a time domain. Since the frequency sweep rate affects a variation coefficient of a target distance to a beat frequency, the distance and velocity information of the target may be separated. The most common manner is a solution of triangular wave modulation whose frequency sweep rates are mutually opposite, see FIG. 1A. FIG. 1B shows a solution of double sideband modulation, that is, a double sideband modulation process implemented by an electro-optical modulator, which directly generates upper/lower sidebands whose frequency sweep rates are mutually opposite, thereby completing the separation of the target distance and velocity information.

For the multi-frequency sweep modulation scheme, the essence of its time division multiplexing makes the decoupling of the target completely dependent on the consistency of the target characteristics detected by each frequency sweep signal. For the solution of triangular wave modulation, whether a rising edge and a falling edge are directed at the same target is a very critical premise. Even if the target is the same, a detection probability problem introduced by the speckle effect in coherent detection will be magnified in the solution of multi-frequency sweep modulation scheme: for example, when a detection probability of a system for a specific target is 90%, a detection probability of the solution of triangular wave modulation is reduced to 81% (=90%×90%), which will greatly affect the quality of a final radar point cloud.

For the double sideband modulation, a very critical indicator is a proportion of single sideband energy in the total energy. The general solution of double sideband modulation includes an intensity modulator and a phase modulator: the intensity modulator has a relatively high effective energy ratio, but a very low modulation efficiency; and the phase modulator has a relatively high modulation efficiency, but a very low the effective energy ratio. Therefore, the solution of double sideband modulation generally require to introduce additional filtering and amplifying modules after performing electro-optical modulation, which increases the cost and complexity of the system.

The FMCW radar may be implemented by a lidar or a millimeter-wave radar.

The content of the background technology is merely technologies known to the inventor, and does not necessarily represent the prior art in the field.

### SUMMARY

In view of at least one defect in the prior art, the present invention provides a detection method using a frequency modulated continuous wave, including the following steps:

emitting a detection wave to detect a target object, where the detection wave is a nonlinear frequency sweep modulation signal;

receiving an echo of the detection wave reflected by the target object;

obtaining an actual beat frequency signal according to the echo and the detection wave; and

obtaining a distance and/or velocity of the target object according to the actual beat frequency signal.

According to an aspect of the present invention, the method further includes:

obtaining a plurality of pre-stored beat frequency signals corresponding to different distances and/or velocities, where

the step of obtaining a distance and/or velocity of the target object according to the actual beat frequency signal further includes:

matching a phase function of the actual beat frequency signal with phase functions of the plurality of pre-stored beat frequency signals, respectively;

selecting a pre-stored beat frequency signal having a highest degree of matching with the actual beat frequency signal; and

using a distance and/or velocity corresponding to the pre-stored beat frequency signal having the highest degree of matching as the distance and/or velocity of the target object.

According to an aspect of the present invention, the plurality of pre-stored beat frequency signals respectively corresponds to different distances, where the step of selecting a pre-stored beat frequency signal having a highest degree of matching with the actual beat frequency signal further includes:

selecting a pre-stored beat frequency signal having a highest degree of matching with a waveform shape of the actual beat frequency signal; and

using a ranging information corresponding to the pre-stored beat frequency signal having the highest degree of matching as the distance of the target object; and

the step of obtaining a distance and/or velocity of the target object according to the actual beat frequency signal further includes:

determining the velocity of the target object according to a frequency difference between the actual beat frequency signal and the pre-stored beat frequency signal having the highest degree of matching.

According to an aspect of the present invention, the plurality of pre-stored beat frequency signals respectively corresponds to different combinations of distances and velocities, and the step of selecting a pre-stored beat frequency signal having a highest degree of matching with the actual beat frequency signal further includes:

selecting a pre-stored beat frequency signal having a highest degree of matching with a waveform shape and a position of the actual beat frequency signal; and

using a distance and velocity corresponding to the pre-stored beat frequency signal having the highest degree of matching as the distance and velocity of the target object.

According to an aspect of the present invention, the nonlinear frequency sweep modulation signal is a quadratic curve function.

According to an aspect of the present invention, the step of obtaining a distance and/or velocity of the target object according to the actual beat frequency signal further includes:

obtaining instantaneous phase information of the actual beat frequency signal;

subtracting the instantaneous phase information of the actual beat frequency signal from phase information of a delayed signal of the actual beat frequency signal;

obtaining distance information of the target object based on a slope of a phase difference between the two; and

obtaining the velocity of the target object according to the distance information and the instantaneous phase information of the actual beat frequency signal.

The present invention further provides a radar, including:

an emitting unit, where the emitting unit is configured to emit a detection wave to detect a target object, where the detection wave is a nonlinear frequency sweep modulation signal;

a receiving unit, configured to receive an echo of the detection wave reflected by the target object and output an echo signal; and

a control unit, where the control unit is coupled to a laser emitter and a detection unit and receives the echo signal, and the control unit is configured to obtain an actual beat frequency signal according to the echo and the detection wave, and obtain a distance and/or velocity of the target object according to the actual beat frequency signal.

According to an aspect of the present invention, the control unit pre-stores a plurality of pre-stored beat frequency signals corresponding to different distances and/or velocities, where

the control unit is configured to:

respectively match a phase function of the actual beat frequency signal with phase functions of the plurality of pre-stored beat frequency signals;

select a pre-stored beat frequency signal having a highest degree of matching with the actual beat frequency signal; and

use a distance and/or velocity corresponding to the pre-stored beat frequency signal having the highest degree of matching as the distance and/or velocity of the target object.

According to an aspect of the present invention, the plurality of pre-stored beat frequency signals respectively corresponds to different distances, where the control unit is configured to:

select a pre-stored beat frequency signal having a highest matching degree of with a waveform shape of the actual beat frequency signal; and

use a ranging information corresponding to the pre-stored beat frequency signal having the highest degree of matching as the distance of the target object; and

determine the velocity of the target object according to a frequency difference between the actual beat frequency signal and the pre-stored beat frequency signal having the highest degree of matching.

According to an aspect of the present invention, the plurality of pre-stored beat frequency signals respectively corresponds to different combinations of distances and velocities, where

the control unit is configured to:

select a pre-stored beat frequency signal having a highest degree of matching with a waveform shape and a position of the actual beat frequency signal; and

use a distance and velocity corresponding to the pre-stored beat frequency signal having the highest degree of matching as the distance and velocity of the target object.

According to an aspect of the present invention, the nonlinear frequency sweep modulation signal is a quadratic curve function.

According to an aspect of the present invention, the control unit is configured to:

obtain instantaneous phase information of the actual beat frequency signal;

subtract the instantaneous phase information of the actual beat frequency signal from phase information of a delayed signal of the actual beat frequency signal;

obtain distance information of the target object based on a slope of a phase difference between the two; and

obtain the velocity of the target object according to the distance information and the instantaneous phase information of the actual beat frequency signal.

The present invention further provides a computer-readable storage medium, storing a computer program code executed by a processor, the code, when executed by one or more processors, causing the processor to perform the method as described above.

The present invention mainly focuses on the problem of distance/velocity information coupling in FMCW radar, and proposes a radar scheme based on nonlinear frequency sweep, which can complete the decoupling and separation of the distance/velocity information in a single cycle. The nonlinear frequency sweep signal used in an embodiment of the present invention has completely independent “perception capability” of a target distance and velocity information: that is, for any state of a detection target, phase information of a beat frequency signal caused by the state of the detection target is uniquely determined. Using the feature, the decoupling and separation of a target distance and velocity, and a subsequent signal processing process may be accomplished without using time division multiplexing and double sideband modulation. An advantage of the present invention is that the decoupling and separation of the distance/velocity can be accomplished within a single frequency sweep cycle, and maintain the detection probability of the system without deteriorating; and at the same time, a single sideband modulation form may allow a system to achieve a relatively high sensitivity.

### BRIEF DESCRIPTION OF THE DRAWINGS

The drawings forming a part of the present disclosure are used to provide further understanding of the present disclosure, and the exemplary embodiments and description of the present disclosure are used to explain the present disclosure but do not constitute an improper limitation on the present disclosure. In the drawings:

FIG. 1A shows a scheme of multi-frequency-sweep modulation in an FMCW radar;

FIG. 1B shows a solution of double sideband modulation in an FMCW radar;

FIG. 2 shows a detection method using a frequency modulated continuous wave according to an embodiment of the present invention;

FIG. 3 shows a time-domain waveform of a nonlinear frequency sweep modulation signal;

FIG. 4A, FIG. 4B, and FIG. 4C respectively show a lateral shift of an echo signal relative to a reference signal and a waveform of a corresponding beat frequency signal at three target object distances;

FIG. 5A, FIG. 5B, and FIG. 5C respectively show a longitudinal shift of an echo signal relative to a reference signal and a waveform of a corresponding beat frequency signal at three target object velocities;

FIG. 6 shows a two-dimensional curved surface representing a degree of matching between a phase function of a beat frequency signal and an echo phase function; and

FIG. 7 is a schematic diagram of a lidar according to an embodiment of the present invention.

### DETAILED DESCRIPTION

Only some exemplary embodiments are briefly described below. As those skilled in the art can realize, the described embodiments may be modified in various different ways without departing from the spirit or the scope of the present invention. Therefore, the accompanying drawings and the description are to be considered as illustrative in nature but not restrictive.

In the description of the present invention, it should be understood that directions or location relationships indicated by terms “center”, “longitudinal”, “landscape”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” are directions or location relationships shown based on the accompanying drawings, are merely used for the convenience of describing the present invention and simplifying the description, but are not used to indicate or imply that a device or an element needs to have a particular direction or needs to be constructed and operated in a particular direction, and therefore, cannot be understood as a limitation to the present invention. In addition, the terms “first” and “second” are used merely for the purpose of description, and shall not be construed as indicating or implying relative importance or implying a quantity of indicated technical features. Therefore, a feature restricted by “first” or “second” may explicitly indicate or implicitly include one or more such features. In the descriptions of the present invention, unless otherwise explicitly specified, “multiple” means two or more than two.

In the description of the present invention, it should be noted that, unless otherwise explicitly stipulated and restricted, terms “installation”, “joint connection”, and “connection” should be understood broadly, which, for example, may be a fixed connection, or may be a detachable connection, or an integral connection; or may be a mechanical connection, or may be an electrical connection, or may be mutual communication; or may be a direct connection, or may be an indirect connection by using a medium, or may be an internal communication between two components, or may be an interactive relationship between two components. Persons of ordinary skill in the art may understand the specific meanings of the foregoing terms in the present invention according to specific situations.

In the present invention, unless otherwise explicitly stipulated and restricted, that a first feature is “on” or “under” a second feature may include that the first and second features are in direct contact, or may include that the first and second features are not in direct contact but in contact by using other features therebetween. In addition, that the first feature is “on”, “above”, or “over” the second feature includes that the first feature is right above and on the inclined top of the second feature or merely indicates that a level of the first feature is higher than that of the second feature. That the first feature is “below”, “under”, or “beneath” the second feature includes that the first feature is right below and at the inclined bottom of the second feature or merely indicates that a level of the first feature is lower than that of the second feature.

Many different implementations or examples are provided in the following disclosure to implement different structures of the present invention. To simplify the disclosure of the present invention, components and settings in particular examples are described below. Certainly, they are merely examples and are not intended to limit the present invention. In addition, in the present invention, reference numerals and/or reference letters may be repeated in different examples. The repetition is for the purposes of simplification and clearness, and a relationship, and does not indicate a relationship between the discussed various implementations and/or configurations. Moreover, the present invention provides examples of various particular processes and materials, but a person of ordinary skill in the art may be aware of application of another process and/or use of another material.

Embodiments of the present invention are described below in detail with reference to the accompanying drawings. It should be understood that the embodiments described herein are merely used to explain the present invention but are not intended to limit the present invention.

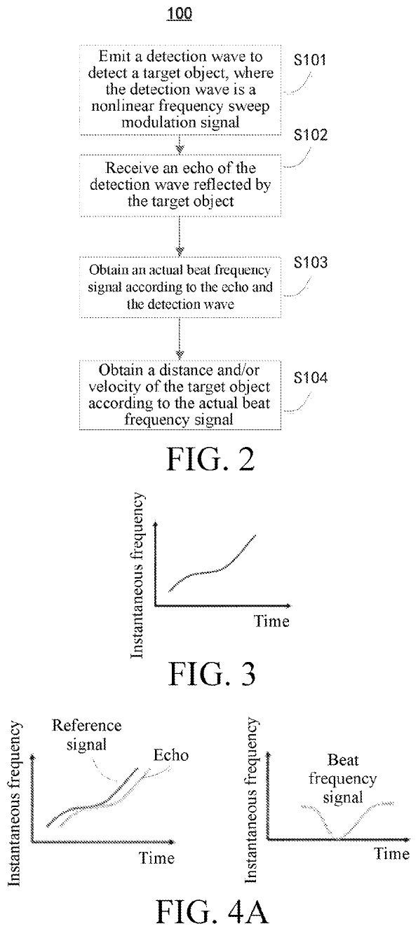

The present invention mainly relates to a modulation signal and a demodulation method thereof in FMCW radar system. FIG. 2 shows a detection method 100 using a frequency modulated continuous wave according to an embodiment of the present invention. A detailed description is made below with reference to the accompanying drawings.

Step S101, a radar emits a detection wave to detect a target object, where the detection wave is a nonlinear frequency sweep modulation signal.

The detection wave may be a nonlinear frequency sweep modulation signal of any order, such as a quadratic function, a cubic function, or even a higher-order function.

In the scheme of the present invention, by transmitting a detection wave of a nonlinear frequency sweep modulation signal, a distance and velocity of a target object may be directly decoupled without using a method such as time division multiplexing or double sideband modulation, thereby avoiding problems caused by such methods, such as a problem of reduced detection probability, a problem of higher system complexity, or the like that may occur. In addition to being used to detect a target object, the nonlinear frequency sweep modulation signal is further used as a reference signal when performing calculation on a distance and velocity of the target object. In addition, in the context of the present invention, the distance of the target object may be represented by an actual distance, or by time of flight TOF of a detection wave (time of flight (d)* speed of light c/2=target distance z). For the sake of uniformity, the actual distance of the target object will be used for illustration.

Step S102. The radar receives an echo of the detection wave reflected by the target object.

An instantaneous frequency of the nonlinear frequency sweep modulation signal of the detection wave is expressed by f₀(t). FIG. 3 shows an example of a time-domain waveform of a nonlinear frequency sweep modulation signal. The detection wave is diffusely reflected by the target object, and the radar receives a diffusely reflected echo to perform signal processing. A delay component and a Doppler frequency shift component of the echo are d and f_{d} respectively, where d corresponds to distance information z of the target object (also reflected as the time of flight of the detection wave), and f_{d} corresponds to velocity information of the target object, and an instantaneous frequency of the echo is f₀(t−d)+f_{d}.

Step S103. Obtain an actual beat frequency signal according to the echo and the detection wave.

A frequency of a beat frequency signal is a difference between the detection wave signal and the echo signal, that is f₀(t)−f₀(t−d)−f_{d}. An instantaneous phase characteristic of the beat frequency signal may be expressed as the following formula (1):

φ(t)=2π∫₀^{t}f₀(τ)−f₀(τ−d)−f_{d}dτ (1)

Step S104. Obtain a distance and/or velocity of the target object according to the actual beat frequency signal.

Let an instantaneous phase of the reference signal be φ₀(t) (that is, integration of f₀(t)), the formula may be written as:

φ(t)=2π[φ₀(t)−φ₀(t−d)−f_{d}t] (2)

When a modulation signal of the detection wave uses a linear frequency sweep, φ₀(t) is a quadratic function of t, the term φ₀(t)−φ₀(t−d) is a first-order coefficient of t, and the term f_{d}t is also a first-order coefficient of t. Therefore, a time delay of a target position and the effect of a velocity f_{d} on φ₀(t) cannot be decoupled.

According to the present invention, when the modulation signal of the detection wave uses a nonlinear frequency sweep, the term φ₀(t)−φ₀(t-d) is not a simple first-order coefficient oft, while the term f_{d}t is still a first-order coefficient oft. Therefore, the effect of a target position z and a velocity v (corresponding to the Doppler frequency shift f_{d}) on φ₀(t) is not the same, which has enough information to achieve the separation of the two.

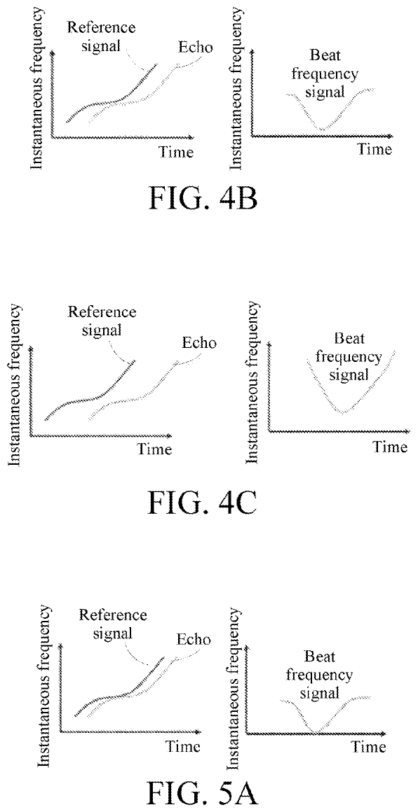

The inventor found that a position of the target object (a distance relative to a position at which the detection wave is emitted) determines a waveform of an actual beat frequency signal. As shown in FIG. 4A, FIG. 4B, and FIG. 4C, it may be seen that for the target object at different distances, waveforms of the actual beat frequency signal are also different. In addition, the position of the target object causes the time delay of the echo signal, which causes an instantaneous frequency curve of the echo signal to shift laterally (time) relative to an instantaneous frequency curve of the reference signal. When the target object is at different distances, the amount of lateral shift that is caused is different, and a shape of a coherent beat frequency result with the reference signal (as shown in a red line in the figure) is also different. In FIG. 4A, FIG. 4B, and FIG. 4C, it is assumed that the velocity (relative velocity) of the target objects is the same, and lateral shifts of the instantaneous frequency curve of the echo signal relative to the instantaneous frequency curve of the reference signal at three target object distances are respectively shown. In FIG. 4A, the target object is at the shortest distance, and therefore, the lateral shift of the echo signal relative to the reference signal is the smallest; In FIG. 4C, the target object is at the farthest distance, and therefore, the lateral shift of the echo signal relative to the reference signal is the greatest; and a case in FIG. 4B is between FIG. 4A and FIG. 4C.

The shape of the beat frequency signal is obtained based on subtracting the phase of the reference signal from the phase of the echo signal. Therefore, for the nonlinear frequency sweep signal, when relative shift positions of the two are different, shapes of the beat frequency signals of the two are different.

A pre-stored signal with the same shape is found based on the shape of the current beat frequency signal, and a distance of the current beat frequency signal is determined based on distance information of the pre-stored signal.

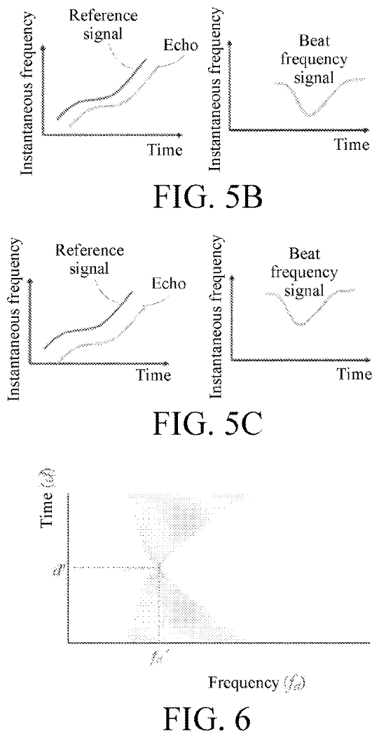

In addition, the velocity of the target object (relative to a velocity of a detection wave emitting device) causes a Doppler frequency shift of the echo signal, which causes the instantaneous frequency curve of the echo signal to shift longitudinally (frequency) relative to the instantaneous frequency curve of the reference signal. When the velocity of the target object is different, the longitudinal displacement that is caused is also different, but a shape of the coherent beat frequency result of the reference signal is not affected, which only shifts longitudinally as well. As shown in FIG. 5A, FIG. 5B, and FIG. 5C, it is assumed that the distance of the target objects is the same, but the velocities of the target objects are different. Because the distance of the target object is the same, the waveform of the coherent beat frequency signal between the echo signal and the reference signal is the same; and because the velocity of the target object is different, the beat frequency signal moves up and down in a direction of a vertical axis.

From the foregoing analysis, it may be learnt that the beat frequency signal actually includes two-dimensional information of the distance and velocity of the target object. A waveform shape of the beat frequency signal may represent the distance of the target object, and the shift of the beat frequency signal in a longitudinal direction (frequency direction) may represent the velocity of the target object. After the actual beat frequency signal is obtained in step S103, the distance and/or velocity of the target object may further be obtained according to the actual beat frequency signal. Therefore, by means of the present invention, the distance of the target object may be uniquely determined based on a “shape” of the instantaneous frequency of the beat frequency signal, and the velocity of the target object may be uniquely determined by a “height” of the instantaneous frequency of the beat frequency signal.

The method 100 further includes: obtaining a plurality of pre-stored beat frequency signals corresponding to different distances and/or velocities. The pre-stored beat frequency signal may be obtained through a plurality of experiments or computer simulation, and each beat frequency signal corresponds to different distances, different velocities, or different combinations of distances and velocities of the target object. That is, each beat frequency signal may have distance information and/or velocity information.

On this basis, after the actual beat frequency signal is obtained, a phase function of the actual beat frequency signal may be respectively matched with phase functions of the plurality of pre-stored beat frequency signals. A pre-stored beat frequency signal having a highest degree of matching with the actual beat frequency signal is selected from the plurality of pre-stored beat frequency signals, and then, a distance and/or velocity corresponding to the pre-stored beat frequency signal having the highest degree of matching is used as the distance and/or velocity of the target object.

For example, when the plurality of pre-stored beat frequency signals respectively corresponds to different combinations of different distances and velocities, the pre-stored beat frequency signal having the highest degree of matching with a waveform shape and a position of the actual beat frequency signal is selected; and a distance and velocity corresponding to the pre-stored beat frequency signal having the highest degree of matching is used as the distance and velocity of the target object.

A phase φ₀(t−d)+f_{d}t of the beat frequency signal corresponding to different target distances (corresponding to different time delays d) and velocities (corresponding to different Doppler frequency shifts f_{d}) may be obtained in advance through experiments or computer simulation, as the pre-stored beat frequency signal. Then, the phase of each pre-stored beat frequency signal is respectively subtracted from the instantaneous phase of the beat frequency signal of the target echo signal that is actually obtained and is accumulated in the time domain, so as to obtain the corresponding accumulated information representing a degree of matching between the phase function and the echo phase function of the beat frequency signal.

FIG. 6 is a schematic diagram of a two-dimensional curved surface showing a degree of matching between an echo signal and each pre-stored signal.

The echo signal is defined as r(t), and then a matching function M(f_{d}, d) between the echo signal and any pre-stored signal is s(t, f_{d}, d) (the time delay is 4 and the Doppler frequency shift is f_{d}) may be expressed as:

$$M ( {f}_{d} , d ) = \frac{\vert {\int }_{- ∞}^{∞} r ( τ ) \cdot s ( τ , {f}_{d} , d ) d τ \vert}{\vert {\int }_{- ∞}^{+ ∞} r ( τ ) d τ \vert \cdot \vert {\int }_{∞}^{+ ∞} s ( τ , {f}_{d} , d ) d τ \vert}$$

The two-dimensional curved surface shown in FIG. 6 is a patterned representation of a matching coefficient M(f_{d}, d). A value of the matching function M is used for indicating a degree of matching between the echo signal and the pre-stored signal, and the greater the value of a matching function M is, the higher the degree of matching is.

For any nonlinear frequency sweep signal, there is only a single peak value in the matching function M. As shown in FIG. 6, the matching coefficient M reaches the maximum value at a point (fd′, d′), which indicates that the echo signal r(t) best matches the pre-stored signal s(t, fd′, d′). Then, d′ and fd′ may be used as the time delay and Doppler frequency shift of the echo signal, so as to determine the distance and velocity information of the target.

The foregoing algorithm is a general algorithm, which may demodulate any form of nonlinear frequency sweep signal, such as a quadratic, cubic, or even higher-order nonlinear frequency sweep signal.

In some embodiments, each pre-stored beat frequency signal may respectively correspond to different distances, and then, the pre-stored beat frequency signal having the highest degree of degree with a waveform shape of the actual beat frequency signal is selected. Then, a ranging information corresponding to the pre-stored beat frequency signal having the highest degree of matching is used as the distance of the target object, that is, the distance information of the target object is obtained. Then, the velocity of the target object is determined according to a frequency difference between the actual beat frequency signal and the pre-stored beat frequency signal having the highest degree of matching.

In addition, each pre-stored beat frequency signal may also respectively correspond to different velocities, and then, the pre-stored beat frequency signal having the highest degree of matching is selected according to a height of the beat frequency signal in a direction of a vertical axis. Velocity information corresponding to the pre-stored beat frequency signal having the highest degree of matching is used as the velocity of the target object, that is, the velocity information of the target object is obtained. Then, based on the velocity information of the target object, the distance of the target object is determined.

In some embodiments, according to an embodiment of the present invention, when the detection wave uses a nonlinear frequency sweep modulation signal of a quadratic function, the distance and/or velocity of the target object may be quickly obtained in the following manners:

obtaining instantaneous phase information of the actual beat frequency signal;

subtracting the instantaneous phase information of the actual beat frequency signal from phase information of a delayed signal of the actual beat frequency signal;

obtaining distance information of the target object based on a slope of a phase difference between the two; and

obtaining the velocity of the target object according to the distance information and the instantaneous phase information of the actual beat frequency signal. The detailed explanation is as follows. The quadratic curve of the detection wave is expressed as follows:

f₀(t)=f_{c}+Kt² (3)

f_{c} is a scanning start frequency, K=B/D² is a frequency sweep coefficient, B is a frequency sweep bandwidth, and D is a frequency sweep cycle.

The instantaneous phase information of the beat frequency signal is:

φ(t)=2π[Kdt²−(Kd²+f_{d})t] (4)

Signal processing is performed on the beat frequency signal. After a fixed time-delay and frequency mixing (multiplication) (the processing is similar to optical coherent detection, and for the instantaneous phase, the time delay-subtraction processing is performed), what is obtained is:

φ′(t)=φ(t)−φ(t−d₀)=2π[2Kdd₀t−(Kd²+f_{d}+Kdd₀)d₀] (5)

Formula (5) is a linear function of t, which indicates that a result obtained by performing processing is a point frequency (that is, a single frequency), and the frequency is 2Kdd₀ (that is, a slope after performing subtraction processing). After a frequency value is obtained by performing FFT search, because two parameters K and do are known, a value of d may be obtained, that is, the distance information of the target object may be obtained.

A characteristic item −2 π Kdt²+Kd² is added to the instantaneous phase of the beat frequency signal, so that a processing result is a point frequency signal with a frequency of fd, and the velocity of the target object may be obtained by obtaining the frequency value through FFT search.

In the method, after obtaining the linear function of t (formula 5), values of a distance d and a velocity v of the corresponding target object may be obtained in a manner of searching for the corresponding frequency value.

In the foregoing embodiments of the present invention, the nonlinear frequency sweep signal used has completely independent “perception capability” of target distance and velocity information: that is, for any state of a detection target, phase information of a beat frequency signal caused by the state of the detection target is uniquely determined. Using the feature, the decoupling and separation of a target distance and velocity and a subsequent signal processing process may be completed in a case that time division multiplexing and double sideband modulation are not used. An advantage of the present invention is that the decoupling and separation of distance/velocity can be completed within a single frequency sweep cycle, and the detection probability of the system is kept from deteriorating; and in addition, a form of single sideband modulation may cause a system to achieve a relatively high sensitivity. In addition, there is no need to add additional devices such as an intensity modulator and a phase modulator, thereby reducing the cost and complexity of a system.

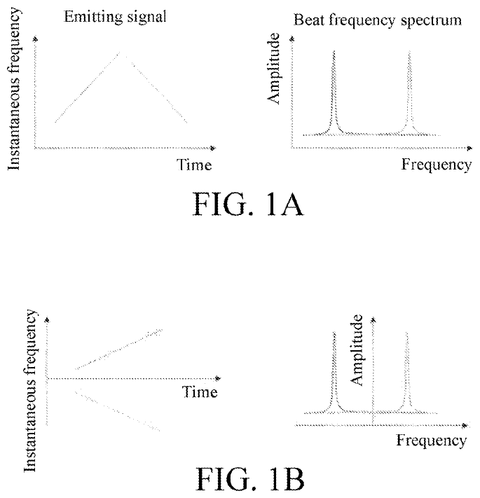

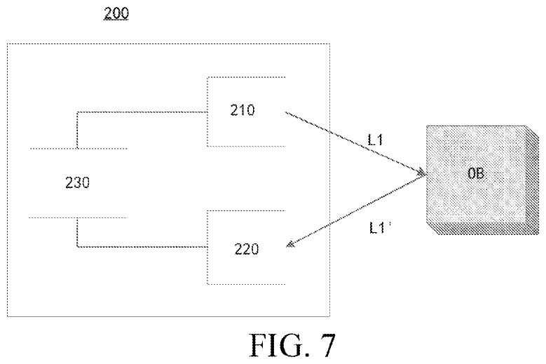

As shown in FIG. 7, the present invention further relates to a radar 200, such as an FMCW lidar, including: an emitting unit 210, a receiving unit 220, and a control unit 230. The emitting unit 210 is configured to emit a detection wave L1 to detect a target object, where the detection wave is a nonlinear frequency sweep modulation signal. The receiving unit is configured to receive an echo L1′ of the detection wave L1 reflected by the target object and output an echo signal. The control unit is coupled to the emitting unit and a detection unit and receives the echo signal, and the control unit is configured to obtain an actual beat frequency signal according to the echo and the detection wave, and obtain a distance and/or velocity of the target object according to the actual beat frequency signal. The control unit may have built-in software, firmware, or a dedicated circuit to perform the method 100 as described above with reference to FIG. 1 to FIG. 6.

According to an embodiment of the present invention, the control unit 230 pre-stores a plurality of pre-stored beat frequency signals corresponding to different distances and/or velocities, and the control unit 230 may be configured to:

respectively match a phase function of the actual beat frequency signal with phase functions of the plurality of pre-stored beat frequency signals;

select a pre-stored beat frequency signal having a highest degree of matching with the actual beat frequency signal; and

use a distance and/or velocity corresponding to the pre-stored beat frequency signal having the highest degree of matching as the distance and/or velocity of the target object.

Optionally, the plurality of pre-stored beat frequency signals respectively corresponds to different distances, where the control unit is configured to:

select a pre-stored beat frequency signal having a highest degree of matching with a waveform shape of the actual beat frequency signal; and

use a ranging information corresponding to the pre-stored beat frequency signal having the highest degree of matching as the distance of the target object; and

determine the velocity of the target object according to a frequency difference between the actual beat frequency signal and the pre-stored beat frequency signal having the highest degree of matching.

Optionally, the plurality of pre-stored beat frequency signals respectively corresponds to different combinations of distances and velocities, where the control unit is configured to:

select a pre-stored beat frequency signal having a highest degree of matching with a waveform shape and a position of the actual beat frequency signal; and

use a distance and a velocity corresponding to the pre-stored beat frequency signal having the highest degree of matching as the distance and the velocity of the target object.

Optionally, the nonlinear frequency sweep modulation signal is a quadratic curve function. According to an embodiment of the present invention, the control unit is configured to:

obtain instantaneous phase information of the actual beat frequency signal;

subtract the instantaneous phase information of the actual beat frequency signal from phase information of a delayed signal of the actual beat frequency signal;

obtain distance information of the target object based on a slope of a phase difference between the two; and

obtain the velocity of the target object according to the distance information and the instantaneous phase information of the actual beat frequency signal.

The present invention further relates to a computer-readable storage medium, storing a computer program code executed by a processor, the code, when executed by one or more processors, causing the processor to perform the method 100 as described above.

It should be finally noted that the foregoing descriptions are merely embodiments of the present invention, but are not intended to limit the present invention. Although the present invention has been described in detail with reference to the foregoing embodiments, for a person of ordinary skill in the art, modifications can be made to the technical solutions described in the foregoing embodiments, or equivalent replacements can be made to some technical features in the technical solutions. Any modification, equivalent replacement, or improvement made within the spirit and principle of the present invention shall fall within the protection scope of the present invention.

What is claimed is:

1. A detection method using a frequency modulated continuous wave, the method comprising:
emitting a detection wave to detect a target object, wherein the detection wave is a nonlinear frequency sweep modulated signal;
receiving an echo of the detection wave reflected by the target object;
obtaining an actual beat frequency signal according to the echo and the detection wave; and
obtaining a distance and/or velocity of the target object according to the actual beat frequency signal.

2. The method according to claim 1, further comprising:
obtaining a plurality of pre-stored beat frequency signals corresponding to different distances and/or velocities, wherein
the operation of obtaining a distance and/or velocity of the target object according to the actual beat frequency signal further comprises:
matching a phase function of the actual beat frequency signal with phase functions of the plurality of pre-stored beat frequency signals;
selecting a pre-stored beat frequency signal having a highest degree of matching with the actual beat frequency signal; and
using a distance and/or velocity corresponding to the pre-stored beat frequency signal having the highest degree of matching as the distance and/or velocity of the target object.

3. The method according to claim 2, wherein the pre-stored beat frequency signals respectively correspond to different distances, wherein the operation of selecting a pre-stored beat frequency signal having a highest degree of matching with the actual beat frequency signal comprises:
selecting a pre-stored beat frequency signal having a highest degree of matching with a waveform shape of the actual beat frequency signal; and
using ranging information corresponding to the pre-stored beat frequency signal having the highest degree of matching as the distance of the target object, wherein
the operation of obtaining a distance and/or velocity of the target object according to the actual beat frequency signal comprises:
determining the velocity of the target object according to a frequency difference between the actual beat frequency signal and the pre-stored beat frequency signal having the highest degree of matching.

4. The method according to claim 2, wherein the pre-stored beat frequency signals respectively correspond to different combinations of distances and velocities, and the operation of selecting a pre-stored beat frequency signal having a highest degree of matching with the actual beat frequency signal comprises:
selecting a pre-stored beat frequency signal having a highest degree of matching with a waveform shape and a position of the actual beat frequency signal; and
using a distance and velocity corresponding to the pre-stored beat frequency signal having the highest degree of matching as the distance and velocity of the target object.

5. The method according to claim 1, wherein the nonlinear frequency sweep modulation signal is a quadratic curve function.

6. The method according to claim 5, wherein the operation of obtaining a distance and/or velocity of the target object according to the actual beat frequency signal comprises:
obtaining instantaneous phase information of the actual beat frequency signal;
subtracting the instantaneous phase information of the actual beat frequency signal from phase information of a delayed signal of the actual beat frequency signal;
obtaining distance information of the target object based on a slope of a phase difference between the instantaneous phase information of the actual beat frequency signal and the phase information of the delayed signal of the actual beat frequency signal; and
obtaining the velocity of the target object according to the distance information and the instantaneous phase information of the actual beat frequency signal.

7. A radar, comprising:
an emitting unit, configured to emit a detection wave to detect a target object, wherein the detection wave is a nonlinear frequency sweep modulation signal;
a receiving unit, configured to receive an echo of the detection wave reflected by the target object and output an echo signal; and
a control unit, wherein the control unit is coupled to the emitting unit and the receiving unit and receives the echo signal, and the control unit is configured to obtain an actual beat frequency signal according to the echo and the detection wave, and obtain a distance and/or velocity of the target object according to the actual beat frequency signal.

8. The radar according to claim 7, wherein the control unit pre-stores a plurality of pre-stored beat frequency signals corresponding to different distances and/or velocities, wherein
the control unit is configured to:
match a phase function of the actual beat frequency signal with phase functions of the plurality of pre-stored beat frequency signals;
select a pre-stored beat frequency signal having a highest degree of matching with the actual beat frequency signal; and
use a distance and/or velocity corresponding to the pre-stored beat frequency signal having the highest degree of matching as the distance and/or velocity of the target object.

9. The radar according to claim 8, wherein the pre-stored beat frequency signals respectively correspond to different distances, wherein the control unit is configured to:
select a pre-stored beat frequency signal having a highest degree of matching with a waveform shape of the actual beat frequency signal; and
use ranging information corresponding to the pre-stored beat frequency signal having the highest degree of matching as the distance of the target object; and
determine the velocity of the target object according to a frequency difference between the actual beat frequency signal and the pre-stored beat frequency signal having the highest degree of matching.

10. The radar according to claim 8, wherein the pre-stored beat frequency signals respectively correspond to different combinations of distances and velocities, wherein
the control unit is configured to:
select a pre-stored beat frequency signal having a highest degree of matching with a waveform shape and a position of the actual beat frequency signal; and
use a distance and a velocity corresponding to the pre-stored beat frequency signal having the highest degree of matching as the distance and the velocity of the target object.

11. The radar according to claim 7, wherein the nonlinear frequency sweep modulation signal is a quadratic curve function.

12. The radar according to claim 11, wherein the control unit is configured to:
obtain instantaneous phase information of the actual beat frequency signal;
subtract the instantaneous phase information of the actual beat frequency signal from phase information of a delayed signal of the actual beat frequency signal;
obtain distance information of the target object based on a slope of a phase difference between the instantaneous phase information of the actual beat frequency signal and the phase information of the delayed signal of the actual beat frequency signal; and
obtain the velocity of the target object according to the distance information and the instantaneous phase information of the actual beat frequency signal.

13. A non-transitory computer-readable storage medium, storing a computer program executable by one or more processors, wherein when executed by the one or more processors, the computer program causes the one or more processors to perform operations comprising:
emitting a detection wave to detect a target object, wherein the detection wave is a nonlinear frequency sweep modulated signal;
receiving an echo of the detection wave reflected by the target object;
obtaining an actual beat frequency signal according to the echo and the detection wave; and
obtaining a distance and/or velocity of the target object according to the actual beat frequency signal.

14. The non-transitory computer-readable storage medium according to claim 13, wherein the operations further comprise:
obtaining a plurality of pre-stored beat frequency signals corresponding to different distances and/or velocities, wherein
the operation of obtaining a distance and/or velocity of the target object according to the actual beat frequency signal further comprises:
matching a phase function of the actual beat frequency signal with phase functions of the plurality of pre-stored beat frequency signals;
selecting a pre-stored beat frequency signal having a highest degree of matching with the actual beat frequency signal; and
using a distance and/or velocity corresponding to the pre-stored beat frequency signal having the highest degree of matching as the distance and/or velocity of the target object.

15. The non-transitory computer-readable storage medium according to claim 14, wherein the pre-stored beat frequency signals respectively correspond to different distances, wherein the operation of selecting a pre-stored beat frequency signal having a highest degree of matching with the actual beat frequency signal comprises:
selecting a pre-stored beat frequency signal having a highest degree of matching with a waveform shape of the actual beat frequency signal; and
using ranging information corresponding to the pre-stored beat frequency signal having the highest degree of matching as the distance of the target object,
wherein the operation of obtaining a distance and/or velocity of the target object according to the actual beat frequency signal comprises:
determining the velocity of the target object according to a frequency difference between the actual beat frequency signal and the pre-stored beat frequency signal having the highest degree of matching.

16. The non-transitory computer-readable storage medium according to claim 14, wherein the pre-stored beat frequency signals respectively correspond to different combinations of distances and velocities, and the operation of selecting a pre-stored beat frequency signal having a highest degree of matching with the actual beat frequency signal comprises:
selecting a pre-stored beat frequency signal having a highest degree of matching with a waveform shape and a position of the actual beat frequency signal; and
using a distance and velocity corresponding to the pre-stored beat frequency signal having the highest degree of matching as the distance and velocity of the target object.

17. The non-transitory computer-readable storage medium according to claim 13, wherein the nonlinear frequency sweep modulation signal is a quadratic curve function.

18. The non-transitory computer-readable storage medium according to claim 17, wherein the operation of obtaining a distance and/or velocity of the target object according to the actual beat frequency signal comprises:
obtaining instantaneous phase information of the actual beat frequency signal;
subtracting the instantaneous phase information of the actual beat frequency signal from phase information of a delayed signal of the actual beat frequency signal;
obtaining distance information of the target object based on a slope of a phase difference between the instantaneous phase information of the actual beat frequency signal and the phase information of the delayed signal of the actual beat frequency signal; and
obtaining the velocity of the target object according to the distance information and the instantaneous phase information of the actual beat frequency signal.
